(19) United States
(12) Patent Application Publication
(10) Pub. No.: US 2015/0152269 A1
(43) Pub. Date: Jun. 4, 2015

(54) ANTIFOG SHEET

(71) Applicant: KIMOTO CO., LTD., Saitama (JP)

(72) Inventors: Masahiro Harada, Saitama (JP); Tetsuji Ohta, Saitama (JP)

(21) Appl. No.: 14/402,592

(22) PCT Filed: May 28, 2013
(86) PCT No.: PCT/JP2013/064727

§ 371 Date: Nov. 20, 2014

(30) Foreign Application Priority Data
May 29, 2012 (JP) 2012-121963

(51) Int. Cl. C09D 5/00; C09D 133/02; C09D 171/02; C09D 129/04; C09D 7/12; C08K 5/3475

(52) U.S. Cl. CPC C09D 5/00; C09D 7/1241; C08K 5/3475; C09D 171/02; C09D 129/04; C09D 133/02

(57) ABSTRACT

Provided is an antifog sheet such that a coated film does not become whitened and the adhesive property of the coated film is not decreased by whitening of the coated film while maintaining antifog property even when the coated film is irradiated with ultraviolet light under high humidity environment and when coated film is in wet state. The antifog sheet of the present invention includes a first layer and a second layer successively layered on a base material. The first layer includes a heat treated product of a first coating composition including a water absorbing resin. The second layer includes a second coating composition including a polyol and a benzotriazole-based ultraviolet light absorber. The amount of the benzotriazole-based ultraviolet light absorber used in the second coating composition is 1.5 to 8 wt % in solid content equivalent.

### TECHNICAL FIELD

The present invention relates to an antifog sheet such that a coated film does not become whitened and the adhesive property of the coated film is not decreased while maintaining antifog property even when irradiated with ultraviolet light under high humidity environment and when the coated film is in a wet state.

### BACKGROUND ART

A base member of glass, plastic, and the like becomes foggy when the surface temperature is decreased to the dew point or below and moisture in the air becomes attached to the surface in the form of fine water droplets, causing irregular reflection of light on the base member surface. The fogging can be prevented by preventing generation of the water droplets on the base member surface. For such antifog purpose, an antifog coating composition including an organic polymer and highly water-repellent surfactant has been proposed. In this composition, a film that is made hydrophilic by polyether polyol in the presence of the surfactant absorbs the moisture, providing antifog property. The composition is designed such that when the hydrophilic film reaches its limit of water absorption, wetness is adjusted by the surfactant so as to maintain transparency. However, the surfactant may be readily dissolved in water and flow out, lowering the antifog property significantly.

In recent years, there has been proposed a composition capable of forming a water-insoluble antifog coated film while providing antifog property, and an antifog sheet including the composition coated on a plastic (Patent Document 1). There has also been proposed an antifog sheet with high water resistance having a laminate structure including a base member on which a first layer for expressing water absorbing in addition to maintaining antifog property, and a second layer for providing water resistance while maintaining antifog property are successively layered, preventing the peeling of a coated film under high humidity environment and when the coated film is in wet state as well as providing antifog performance (Patent Document 2)

### CITATION LIST

### Patent Literatures

### Patent Document 1: JP-A-11-61029

### Patent Document 2: JP-A-2011-25692

### SUMMARY OF THE INVENTION

### Problem to be Solved by the Invention

The above-described antifog sheet including two stacked layers of antifog coated films is superior to conventional antifog sheets in antifog and water resistance properties. However, when irradiated with ultraviolet light under high humidity environment and when the coated films are in wet state, the coated films may become whitened, and the adhesive property of the coated films may be decreased.

Patent Document 2 describes the addition of a benzophenone compound as an ultraviolet light absorber to the antifog property expressing first layer so as to increase weather resistance of the antifog coated film. However, an analysis by the present inventors showed that the configuration cannot prevent whitening of the coated film of the second layer and decrease in the coated film adhesive property between the first layer and the second layer. Further, when the benzophenone compound is added to the second layer instead of the first layer, there arises a new problem of deterioration in antifog property.

Thus, the purpose of the present invention is to provide an antifog sheet such that a coated film does not become whitened and the adhesive property of the coated film is not decreased while maintaining antifog property when irradiated with ultraviolet light even under high humidity environment and when the coated film is in wet state.

### Solution to the Problems

Based on research and analysis of the problem, the present inventors found that by adding a specific amount of a benzotriazole-based ultraviolet light absorber with a relatively small molecular weight, among other ultraviolet light absorbers, into the coated film of the second layer, there can be obtained an antifog sheet such that a coated film does not become whitened and the adhesive property of the coated film is not decreased while maintaining antifog property even when irradiated with ultraviolet light under high humidity environment and when the coated film is in wet state.

An antifog sheet of the present invention includes a first layer and a second layer successively layered on a base material. The first layer includes a water absorbing resin, and the second layer includes a polyol and a benzotriazole-based ultraviolet light absorber with a molecular weight of not more than 500. The second layer has a benzotriazole-based ultraviolet light absorber content of 1.5 to 8 wt %.

The first layer may include a heat treated product of a first coating composition including a water absorbing resin. The second layer may include a heat treated product of a second coating composition including a polyol and a benzotriazole-based ultraviolet light absorber.

In the antifog sheet of the present invention, preferably, the molecular weight of the benzotriazole-based ultraviolet light absorber may be not more than 350. Preferably, the benzotriazole-based ultraviolet light absorber content may be not more than 5 wt %.

In the antifog sheet of the present invention, preferably, the water absorbing resin may include at least one of a polyvinyl alcohol and a polyacrylic acid. More preferably, the water absorbing resin may include a polyvinyl alcohol and a polyacrylic acid.

In the antifog sheet of the present invention, preferably, at least one of the first coating composition and the second coating composition may include at least one compound selected from a metal alkoxide, a hydrolysate of a metal alkoxide, and a hydrolyzed polycondensate of a metal alkoxide.

In the antifog sheet of the present invention, preferably, at least one of the first coating composition and the second coating composition may include a curing agent.

The term “under high humidity environment” in the present invention refers to an environment with relative humidity of 70% or more.

### Effects of the Invention

According to the present invention, a specific ultraviolet light absorber is included in a second layer of an antifog sheet in which a first layer and the second layer are successively layered on a base material. Thus, the first layer and the second layer can be provided with weather resistance without inhibiting the characteristics of the first layer. Particularly, a high ultraviolet light preventing function can be provided under high humidity environment and when the coated film is in wet state where the antifog sheet may be exposed. Further, by using a specific amount of a benzotriazole-based ultraviolet light absorber as the ultraviolet light absorber in the second layer, the ultraviolet light absorber can be included with good compatibility in the second layer having high cross link strength, making it possible to maintain the function of the second layer to maintain antifog property and provide water resistance. As a result, there can be provided an antifog sheet such that a coated film does not become whitened and the adhesive property of the coated film is not decreased by the whitening of the coated film while maintaining antifog property even when irradiated with ultraviolet light under high humidity environment and when the coated film is in wet state.

### DESCRIPTION OF EMBODIMENTS

An antifog sheet according to the present invention includes a base member on which a first layer and a second layer are successively layered. The first layer may include a heat treated product of a first coating composition including a water absorbing resin. The second layer may include a heat treated product of a second coating composition including polyol and a benzotriazole-based ultraviolet light absorber. The amount of the benzotriazole-based ultraviolet light absorber used in the second coating composition is 1.5 to 8 wt % in solid content equivalent.

The first coating composition of the first layer includes at least a water absorbing resin. The water absorbing resin is used for causing the first layer to express water absorbing and antifog properties when the first coating composition is heat-processed into a coated film.

Examples of the water absorbing resin include polyvinyl alcohol (which may hereafter be abbreviated as “PVA”), polyacrylic acids, and polyvinylpyrrolidone. These resins may be used independently or in combination of two or more kinds.

According to the present invention, preferably, as the water absorbing resin, at least one of PVA and polyacrylic acids may be used. More preferably, from the viewpoint of achieving high water absorbing and antifog properties when formed into a coated film, a mixture of PVA and polyacrylic acids may be used as the water absorbing resin. When the mixture of PVA and polyacrylic acids is used as the water absorbing resin, the ratio of the polyacrylic acids to PVA (polyacrylic acids/PVA) may preferably be 5/95 to 50/50 in weight equivalent. As the amount of polyacrylic acids used relative to PVA increases, the antifog property tends to be decreased, whereas as the amount decreases, the water resistance of the coated film tends to be decreased.

As PVA, preferably an incomplete saponified product (which may be referred to as “partial saponified product”) with the saponification degree of 65 to 89 mol % [i.e., the mole number of hydroxyl group×100/(mole number of acetyl group+mole number of hydroxyl group)]. More preferably, incomplete saponified PVA with the saponification degree of 75 to 89 mol % may be used. If the saponification degree is too high or too low, the water absorbing and antifog properties may not be expressed in a balanced manner.

The average polymerization degree of PVA is not particularly limited and may preferably be from 300 to 3500. If the polymerization degree is too high or too low, the water absorbing and antifog properties may not be expressed in a balanced manner.

Examples of polyacrylic acids include polyacrylic acid, polymethacrylic acid, methyl ester or ethyl ester of polyacrylic acid, and methyl ester or ethyl ester of polymethacrylic acid. As the methyl ester or ethyl ester of polyacrylic acid or as the methyl ester or ethyl ester of polymethacrylic acid, an incomplete saponified product with the saponification degree of 10 to 30 mol % [i.e., mole number of hydrolyzed ester group×100/(mole number of hydrolyzed ester group+mole number of ester group that is not hydrolyzed)].

Preferably, the amount of the water absorbing resin used in the first coating composition may be 20 to 99.5 wt % in solid content equivalent and more preferably 50 to 90 wt %. By using the water absorbing resin in this range, the water absorbing and antifog properties can be expressed in a balanced manner.

Preferably, when PVA is used as the water absorbing resin, the amount of PVA used in the first coating composition may be 50 to 95 wt % in solid content equivalent. When the polyacrylic acid are used as the water absorbing resin, the amount of the polyacrylic acid used in the first coating composition may be preferably 5 to 50 wt % in solid content equivalent.

Preferably, the first coating composition may include at least one compound (which may hereafter be referred to as “metal alkoxide or the like”) selected from metal alkoxide, hydrolysate of metal alkoxide, and hydrolyzed polycondensate of metal alkoxide, in addition to the above-described water absorbing resin.

By preferably including metal alkoxide or the like in the first coating composition, in the process of forming the first coating composition into a coated film, when a hydrolysate of the metal alkoxide causes a polycondensation reaction, the hydrolysate also reacts with a coexisting water absorbing resin, producing a complex polymer having an inorganic portion deriving from the metal alkoxide and an organic portion having a hydrophilic group deriving from the water absorbing resin. It is thought that the hydrophilic group of the complex polymer is effectively oriented, enabling the absorption of moisture from outside in large amounts and rapidly. As a result, there can be provided a coat (first layer) having high antifog property and also providing insolubility, wear resistance, and weather resistance which are required from an antifog coated film.

The hydrolysate of metal alkoxide and the hydrolyzed polycondensate of metal alkoxide refer to a hydrolysate obtained by causing metal alkoxide to hydrolysis and polycondensation reactions in a solution by a so-called sol-gel process reaction, making the obtained solution into a sol in which fine particles of metal oxide or metal hydroxide are dissolved, and further causing the reaction to proceed until a gel is obtained, and a subsequent hydrolyzed polycondensate. As the hydrolyzed polycondensate of metal alkoxide, a low molecular weight polycondensate having a weight average molecular weight (Mw) on the order of several hundreds to several tens of thousands in polystyrene equivalent according to GPC method may be used.

The metal alkoxide includes a compound expressed by the following expression (I):

M(OR)n(X)a−n (I)

where M is an atom selected from Si, Al, Ti, Zr, Ca, Fe, V, Sn, Li, Be, B, and P; R is an alkyl group; X is an alkyl group, an alkyl group having a functional group, or halogen; a is the valence of M; and n is an integer of 1 to a. Of the compounds according to expression (I), one that may be generally used is a compound with n=a where only an alkoxy group is bound to M.

When M is Si, a of expression (I) is 4 where the alkoxide is expressed by Si(OR1)₄, where R1 is preferably an alkyl group with carbon number of 1 to 4 (which is hereafter referred to as a lower alkyl group). Examples of such alkoxysilane (silicon alkoxide) include tetramethoxy silane (or methyl silicate) of Si(OCH3)₄, and tetraethoxysilane (or ethylsilicate) of Si(OC₂H₅)₄. The amount of alkoxysilane used in metal alkoxide is preferably 50 to 100 wt %.

When M is Al, a in the expression (I) is 3, and such alkoxide is expressed by Al(OR2)₃, where R2 is preferably a lower alkyl group. Examples of such aluminum alkoxide include Al(OCH₃)₃, Al(OC₂H₅)₃, Al(O-n-C₃H7)₃, Al(O-iso-C₃H7)₃, and Al(OC₄H₉)₃. The aluminum alkoxide may be used independently or in combination of two or more kinds Such aluminum alkoxide is normally mixed with the alkoxysilane when used. By using the aluminum alkoxide, the light transmitting property and heat resistance of the obtained antifog coated film can be increased. The amount of the aluminum alkoxide used in metal alkoxide is preferably in the range of from 1 to 10 parts by weight with respect to 100 parts by weight alkoxysilane.

When M is Ti, a in the expression (I) is 4, and such alkoxide is expressed by Ti(OR3)₄, where R3 is preferably a lower alkyl group. Examples of such titanium alkoxide include Ti(O—CH₃)₄, Ti(O—C₂H₅)₄, Ti(O-n-C₃H₇)₄, Ti(O-iso-C₃H₇)₄, and Ti(O—C₄H₉)₄. The titanium alkoxide may be used independently or in a mixture of two or more kinds Such titanium alkoxide is normally mixed with the alkoxysilane when used. By using the titanium alkoxide, the ultraviolet light resistance of the obtained antifog coated film can be increased, and the heat resistance of the base member is also significantly increased. The amount of the titanium alkoxide used in metal alkoxide is preferably in the range of from 0.1 to 3 parts by weight with respect to 100 parts by weight of alkoxysilane.

When M is Zr, a in the expression (I) is 4, and such alkoxide is expressed by Zr(OR4)₄, where R4 is preferably a lower alkyl group. Examples of such zirconium alkoxide include Zr(OCH₃)₄, Zr(OC₂H₅)₄, Zr(O-iso-C₃H₇)₄, Zr(O-t-C₄H₉)₄, and Zr(O-n-C₄H₉)₄. The zirconium alkoxide may be used independently or in combination of two or more kinds Such zirconium alkoxide is normally used in a mixture with the alkoxysilane. By using zirconium alkoxide, the toughness and heat resistance of the obtained antifog coated film can be increased. The amount of the zirconium alkoxide in the metal alkoxide is preferably 0.5 to 5 parts by weight with respect to 100 parts by weight of alkoxysilane.

Other examples of alkoxide include Ca(OC₂H₅)₂, Fe(OC₂H₅)₃, V(O-iso-C₃H₇)₄, Sn(O-t-C₄H₉)₄, Li(OC₂H₅), Be(OC₃H₅)₂, B(OC₂H₅)₃, P(OC₂H₅)₂, and P(OCH₃)₃.

An example of the alkoxide according to expression (I) where n is not more than a-1, i.e., an example of a compound where a group X other than alkoxide is bound to M, is a compound where X is halogen such as Cl or Br. In a compound where X is halogen, an OH group is produced by hydrolysis in the same way as for alkoxy group as will be described later, causing a polycondensation reaction. X may also be an alkyl group or an alkyl group having a functional group, and the carbon number of the alkyl group is normally 1 to 15. Such groups are not hydrolyzed and remain in the obtained polymer as an organic portion. Examples of the functional group include carboxyl group, carbonyl group, amino group, vinyl group, and epoxy group. Such groups are preferable for increasing antifog property as will be described later.

Examples of the compound according to expression (I) having X include vinyltrichlorosilane, vinyltrimethoxysilane, vinyltriethoxysilane, γ-methacryloxypropyltrimethoxysilane, γ-glycidoxypropyltrimethoxysilane, and γ-aminopropylmethoxysilane.

The amount of metal alkoxide or the like in the first coating composition when the metal alkoxide or the likes included in the first coating composition is preferably 0.5 to 50 wt % in solid content equivalent.

Preferably, the first coating composition used in the present invention includes a silane coupling agent from the viewpoint of adhesion with the base member. The silane coupling agent contributes to the formation of a complex polymer having a three-dimensional structure including an organic portion and an inorganic portion, as does the metal alkoxide or the like, whereby insolubility can be increased while absorbency is maintained.

Examples of the silane coupling agent include vinylsilane, methacrylsilane, aminosilane, and epoxysilane. Particularly, it is preferable to use, among others, the silane coupling agent having an epoxy group. A preferable example of the silane coupling agent having an epoxy group is γ-glycidoxypropyltrimethoxysilane which is also a metal alkoxide. The amount of the silane coupling agent in the first coating composition when the silane coupling agent is included in the first coating composition is preferably 0.2 to 10 wt % in solid content equivalent.

When the metal alkoxide or the like is included in the first coating composition, it is preferable that the first coating composition further includes a catalyst. An example of the catalyst is an acid catalyst. The acid catalyst is used for hydrolysis reaction of metal alkoxide. Thus, the metal alkoxide is hydrolyzed in advance to some extent and polycondensed, producing a polymer having an OH group (which may be an oligomer of relatively low molecular weight).

Examples of the acid catalyst include mineral acids, such as hydrochloric acid, sulfuric acid, and nitric acid. An anhydride of mineral acid (such as hydrochloric gas) may also be used. Other examples include organic acids and anhydride thereof. Examples of the organic acid and an anhydride thereof include tartaric acid, phthalic acid, maleic acid, dodecyl succinic acid, hexahydrophthalic acid, methylnadic acid, pyromellitic acid, benzophenone tetra carboxylic acid, dichlorosuccinic acid, chlorendic acid, anhydrous phthalic acid, anhydrous maleic acid, anhydrous dodecylsuccinic acid, anhydrous hexahydrophthalic acid, anhydrous methylnadic acid, anhydrous pyromellitic acid, anhydrous benzophenone tetracarboxylic acid, anhydrous dichlorosuccinic acid, and anhydrous chlorendic acid. When an acid catalyst is included in the first coating composition, the amount of the acid catalyst is preferably 0.01 to 0.5 parts by weight and more preferably from 0.015 to 0.3 parts by weight with respect to 100 parts by weight of the metal alkoxide.

Further, an organic acid deriving from the saponified portion of the polyacrylic acid ester acts as a catalyst for the hydrolysis/polycondensation reaction of the alkoxide or preferably for alkoxide and γ-glycidoxypropyltrimethoxysilane.

As described above, the first coating composition used in the present invention includes the reaction solution including a water absorbing resin (such as PVA or polyacrylic acids), further preferably including a metal alkoxide or the like, and further including a catalyst (that promotes the polycondensation reaction of a hydrolysate of a metal alkoxide that may be included in a specific compound). The at least one compound selected from a metal alkoxide, a hydrolysate of a metal alkoxide, and a polycondensate of the hydrolysate including the metal alkoxide or the like include the following four cases:

(1) where a metal alkoxide is used for preparing a reaction solution, and the hydrolysis reaction is caused after the reaction solution is prepared.
(2) where a hydrolysate of a metal alkoxide that has already been subjected to hydrolysis reaction process is used for preparing the reaction solution.
(3) where a low molecular weight polycondensate of a hydrolysate of a metal alkoxide that has already been partially polycondensed is used for preparing the reaction solution.
(4) where two or more kinds among a metal alkoxide, a hydrolysate thereof, and a low molecular weight polycondensate of the hydrolysate are used for preparing the reaction solution.

The first coating composition used in the present invention may further include a curing agent. Examples of the curing agent include an isocyanate-based curing agent, an epoxy-based curing agent, a carbodiimide-based curing agent, and a melamine-based curing agent.

When the curing agent is included in the first coating composition, the amount of the curing agent in the first coating composition is preferably from 0.5 to 20 wt % in solid content equivalent.

The first coating composition may further include hydrofluorosilicic acid. When the hydrofluorosilicic acid is included in the first coating composition, the amount of the hydrofluorosilicic acid in the first coating composition is preferably from 0.2 to 10 wt %.

The first coating layer is normally used in the form of a coating liquid to form a first layer. For example, the coating liquid may be prepared by dissolving or dispersing the above-described water absorbing resin (and further a metal alkoxide or the like as needed) in an organic solvent. Preferable examples of the organic solvent include solvents with compatibility with water, such as methyl alcohol, ethyl alcohol, isopropyl alcohol, butyl alcohol, and N-methyl pyrrolidone. More preferably, the organic solvent is used with water. The amount of the organic solvent in the first coating composition is preferably 0 to 60 wt %. The amount of the organic solvent may be 0 (zero) because there may be cases where the coating liquid form may be obtained without using an organic solvent.

The major composition of the first coating composition is obtained by causing a sol-gel reaction in the presence of a water absorbing resin. Thus, examples include a polycondensate obtained by a polycondensation reaction as a result of deprotonation of an OH group of a hydrolysate of a metal alkoxide, the complex polymer described above obtained by cross-linking reaction of a water absorbing resin with an OH group of a polycondensate, a reactant of a hydrolysate of a metal alkoxide and a water absorbing resin, and a reactant of the three of the polycondensate, the hydrolysate, and the water absorbing resin.

A second coating composition including the second layer of the antifog sheet according to the present invention will be described. The second coating composition includes at least polyol and a benzotriazole-based ultraviolet light absorber. The polyol is used for providing water resistance in addition to maintaining the antifog property expressed by the first layer when the second coating composition is heat-processed into a coated film. The benzotriazole-based ultraviolet light absorber is used for preventing the coated film of the first layer and the second layer from becoming whitened and decrease in the adhesive property of the coated film while maintaining the antifog property expressed by the first layer even when the coated film is irradiated with ultraviolet light under high humidity environment and when the coated film is in wet state.

Examples of the polyol include polyester, acrylic, partially acetalized polyvinyl alcohol, polyethylene glycol, and polyvinylpyrrolidone. These may be used independently or in combination of two or more kinds Particularly, from the viewpoint of maintaining antifog property, it is preferable to use polyethylene glycol. The amount of polyol in the second coating composition is preferably from 10 to 80 wt % and more preferably from 30 to 80 wt % in solid content equivalent.

Available examples of the benzotriazole-based ultraviolet light absorber include Eversorb (trade name) series 70 to 78, 80, 81, and 109 provided by Everlight Chemical Industrial Corp.; Sumisorb (trade name) series 200, 250, 300, 340, and 350 provided by Sumika Chemtex Co., Ltd.; Adeka Stab LA (trade name) series LA-29, LA-31, LA 32, and LA 36 provided by Adeka Corporation; and Kemisorb (trade name) series 71, 73, 74 provided by Chemipro-sha. Among such benzotriazole-based ultraviolet light absorbers, the present invention uses a benzotriazole-based ultraviolet light absorber with a molecular weight of not more than 500 and preferably not more than 350.

Specific examples of the benzotriazole-based ultraviolet light absorber with molecular weight of not more than 500 include 2-(2-hydroxy-5-methyl phenyl) benzotriazole; 2-(5-tertiary-butyl-2-hydroxyphenyl)benzotriazole; 2-(5-chloro-2-benzotriazolyl)-6-tertiary-butyl-p-cresol; and 2-(2-hydroxy-5-tertiary-octylphenyl)benzotriazole. The benzotriazole-based ultraviolet light absorber with the molecular weight of not more than 500 has high compatibility with the polyol including the coated film or other compositions and can prevent whitening of the coated film of the first layer or the second layer without inhibiting antifog property. These may be used independently or in combination of two or more kinds.

The amount of the benzotriazole-based ultraviolet light absorber in the second coating composition is 1.5 to 8 wt % and preferably 1.9 to 5 wt % in solid content equivalent. By making the amount used 1.5 wt % or more, sufficient ultraviolet light absorbing function for preventing whitening of the coated film can be obtained. By making the amount used 5 wt %, degradation in antifog property can be prevented.

Preferably, the second coating composition includes a metal alkoxide or the like as in the first coating composition. The amount of the metal alkoxide or the like in the second coating composition is preferably 0.5 to 50 wt % in solid content equivalent.

When the metal alkoxide or the like is included in the second coating composition, the same catalyst as in the first coating composition may be included. In this case, the amount used is the same as in the first coating composition.

Preferably, the second coating composition includes the same silane coupling agent as in first coating composition. The amount of the silane coupling agent in the second coating composition is the same as in the first coating composition.

Preferably, the second coating composition further includes a curing agent. Examples of the curing agent include an isocyanate-based curing agent, an epoxy-based curing agent, a carbodiimide-based curing agent, and a melamine-based curing agent.

The isocyanate-based curing agent may include polyisocyanate including a polymerization or copolymerization of isocyanate monomers as a main example, and may be used without any particularly limitation. Examples of the isocyanate monomer include 1,6-hexamethylene diisocyanate, isophorone diisocyanate, 1,3- or 1,4-diisocyanate cyclohexane, m- or p-tetra methylxylene diisocyanate, 1,4-tetramethylene diisocyanate, and 1,12-dodecamethylene diisocyanate.

A one-component curable isocyanate that does not react at all at normal temperature and causes a cross-linking reaction when heated to a certain temperature or above may also be used. An example of such isocyanate is block isocyanate employing a catalyst or functional group blocking technique.

The block isocyanate herein refers to the above-described polyisocyanate that has been masked with a masking agent. At normal temperature, the block isocyanate does not react at all and no curing reaction proceeds. When heated to a temperature or above at which the masking agent is dissociated, active isocyanate groups are reproduced and a sufficient cross-linking reaction is caused.

Examples of the epoxy-based curing agent include ethylene glycol glycidyl ether, polyethylene glycol glycidyl ether, glycerol polyglycidyl ether, and sorbitol polyglycidyl ether. Examples of the carbodiimide-based curing agent include dicyclohexyl carbodiimide, diisopropyl carbodiimide, and 1-ethyl-3-(3-dimethyl amino propyl) carbodiimide hydrochloride. Examples of the melamine-based curing agent include completely alkyl-etherified melamine resin, methylol group-type melamine resin, and an imino group-type melamine resin partially having an imino group.

The amount of the curing agent in the second coating composition is preferably 10 to 80 wt % and more preferably from 30 to 60 wt % in solid content equivalent.

Preferably, the second coating composition includes hydrofluorosilicic acid as in the first coating composition. The amount of the hydrofluorosilicic acid in the second coating composition is the same as in the first coating composition.

The second coating composition is also normally used in the form of a coating liquid to form the second layer, as in the case of the first coating composition. For example, the coating liquid may be prepared by dissolving or dispersing the above-described polyol, benzotriazole-based ultraviolet light absorber, and, as needed, a metal alkoxide or the like and a curing agent, in an organic solvent. Preferable examples of the organic solvent include solvents having compatibility with water, such as methyl alcohol, ethyl alcohol, isopropyl alcohol, butyl alcohol, N-methyl pyrrolidone, and diacetone alcohol. The amount of the organic solvent in the second coating composition is preferably 50 to 90 wt %.

Because the second layer formed on the first layer is a coated film in which the polyol is cross-linked, the coated film has a high cross-linking density. Thus, water resistance can be further provided while maintaining the antifog property expressed by the first layer. Specifically, even under high humidity environment and when the base member is in wet state, the coated films (the first layer and the second layer) are not peeled even if scrubbed with dry waste cloth or a finger and the like, thus providing high water resistance. Because the second layer includes a specific amount of benzotriazole-based ultraviolet light absorber, whitening of the coated film of the first layer and the second layer, and decrease in the coated film adhesive property can be prevented while maintaining the antifog property expressed by the first layer, even when the coated film is irradiated with ultraviolet light under high humidity environment and when the coated film is in wet state.

As the base member for layering the first layer and the second layer, mainly glass or plastic film may be cited. An example of the glass is an oxide glass, such as silicate glass, phosphate glass, or borate glass, that is used in the form of a plate glass. Particularly, preferable examples include silicate glasses such as silicate glass, silicate alkali glass, soda lime glass, potash lime glass, lead glass, barium glass, or borosilicate glass in the form of a plate glass. Examples of the plastic film include polyethylene terephthalate, polybutylene terephthalate, polyethylene naphthalate, polycarbonate, polyethylene, polypropylene, polystyrene, triacetylcellulose, acrylic, polyvinyl chloride, and norbornene compound. Particularly, a polyethylene terephthalate film that has been drawn, particularly biaxially drawn, may be suitably used because of its mechanical strength and dimensional stability.

Preferably, the base member used in the present invention is subjected to easy adhesion treatment. By using the base member with a surface provided with easy adhesion treatment, compared with the base member without the treatment, an improvement in adhesive property with the first layer and an adhesive layer which will be described later can be obtained. Examples of the easy adhesion treatment include various surface treatments (such as plasma treatment, corona treatment, chemical/activation treatment, oxidizing flame treatment, or far ultraviolet light irradiation treatment), and the formation of an undercoating easy adhesion layer. Preferably, the base member has a thickness of from 12 to 188 μm.

Examples of a binder component in the undercoating easy adhesion layer include acrylic-based, polyester-based, silicon-based, urethane-based, styrene-based, cellulose-based, vinyl-based, epoxy-based, butyral-based, amino-based, and rubber-based binder components. Among others, a polyester-based binder component may be particularly preferably used from the viewpoint of adhesive property with the base member and the first layer and workability.

Preferably, the undercoating easy adhesion layer has a thickness of from 0.05 to 3 μm and more preferably from 0.5 to 2 μm from the viewpoint of adhesive property with the base member and the first layer and workability.

The antifog sheet according to the present invention may have the adhesive layer formed on the surface of the base member opposite from the surface on which the first layer is formed. Preferable examples of an adhesive agent used in the adhesive layer include generally used synthetic resin-based adhesive agents, such as acrylic-based, silicone-based, urethane-based, or rubber-based adhesive agents. From the viewpoint of handling and the like, an acrylic-based adhesive agent is preferably used. An example of an adhesive polymer as a principal component of such acrylic-based adhesive agent is a copolymerization of a monomer mixture including, as principal components, a (meth)acrylic acid alkyl ester with the alkyl group carbon number of 1 to 10, such as 2-ethylhexyl acrylate, butyl acrylate, isooctyl acrylate, butyl methacrylate, or propyl methacrylate, and a functional group-containing unsaturated monomer such as acrylic acid, methacryl acid, maleic acid, fumaric acid, hydroxyethyl acrylate, or hydroxyethyl methacrylate. These adhesive layers may include various additives, such as an ultraviolet light absorber, an infrared absorber, a curing agent, a plasticizer, or an adhesiveness providing component, to the extent that the effect of the present invention is not inhibited.

The thickness of the adhesive layer is not particularly limited and may be selected as needed depending on the material of the base member. Specifically, the thickness may be from 0.5 μm to 50 μm and preferably from 5 to 30 μm.

The antifog sheet according to the present invention is manufactured as described below, for example. First, the various components of the first coating composition are mixed to prepare a transparent first coating liquid (which is synonymous with the first coating composition according to the present invention). Further, the various components of the second coating composition are mixed to prepare a transparent second coating liquid (which is synonymous with the second coating composition according to the present invention). Then, the first coating liquid is applied to at least one surface of the base member and is heated and dried at temperatures in the range of preferably 80° C. or more and more preferably from 80 to 150° C. (heating process), whereby the first layer is formed on the base member. The heating process may be performed after the coating liquid is applied in a plurality of layers as needed.

Then, the second coating liquid is applied to the first layer formed on the base member, and is heated and dried at temperatures in the range of preferably 60° C. or above and more preferably in the range of from 60 to 150° C. (heating process), whereby the second layer is formed on the first layer. The heating process may be performed after the coating liquid is applied in a plurality of layers as needed.

When the antifog sheet of the present invention is provided with an adhesive layer, an adhesive layer coating liquid is prepared by dissolving or dispersing materials of the adhesive layer in an appropriate solvent and adjusting the mixture. Then, the surface of the base member opposite to the surface on which the first layer is formed is coated with the prepared adhesive layer coating liquid by coating method well known in the art and then dried, followed by curing as needed, thus forming the adhesive layer.

Preferably, in the antifog sheet according to the present invention, a total of the thickness (T1) of the first layer and the thickness (T2) of the second layer is from 0.01 to 1.0 μm when used for optical lens and the like. When applied to a window glass and the like, the total thickness is preferably from 1.0 to 10.0 μm. The total thickness of the first layer and the second layer (T1+T2) can be adjusted as needed by thickly applying each coating composition in the form of coating liquid, or by applying each coating composition in a plurality of layers. In this way, the resultant antifog article is provided with antifog and anti-dew condensation properties on the surface of the base member. The formed coated film (first layer+the second layer) is insoluble in water and organic solvent, and has high surface hardness.

According to the present invention, when the first coating composition is applied to the base member and subjected to heating and drying (heating process), the polycondensation reaction and cross-linking reaction proceed, whereby a complex polymer having a three-dimensional structure is formed. The complex polymer includes an inorganic portion and an organic portion. Namely, the polymer includes an insoluble framework which is the inorganic portion, so that the antifog coated film formed by the polymer is insoluble to water and organic solvent and has high surface hardness. Further, the polymer includes a hydrophilic portion deriving from water absorbing resin (such as polyacrylic acid ester or PVA) which is the organic portion, so that the coated film by the polymer includes the hydrophilic portion present at the surface portion thereof where moisture is adsorbed. Further, when a carboxyl group, a carbonyl group, an amino group, a vinyl group, or an epoxy group and the like is provided to the terminus of the X group of the expression (I), moisture is also adsorbed on the group.

When the antifog sheet is such that only the first layer including a heat treated product of the first coating composition is formed on the base member, the curing reaction/cross-linking reaction of the organic matter including the coated film is still insufficient. Thus, if the coated film (first layer) is scrubbed with dry waste cloth or a finger and the like under high humidity environment and when the base member is in wet state, the organic matter readily moves, causing the coated film to peel.

On the other hand, the antifog sheet according to the present invention is additionally provided with the second layer including the heat treated product of the second coating composition on the first layer. Because the second layer has a high coated film cross-linking density, the second layer can additionally provide water resistance while maintaining the antifog property expressed by the first layer. Specifically, even if the coated films (the first layer and the second layer) are scrubbed with dry waste cloth or a finger and the like under high humidity environment and when the base member is in wet state, the coated films are not peeled, thus providing high water resistance. Further, because the second layer includes a specific amount of benzotriazole-based ultraviolet light absorber, whitening of the coated film of the first layer and the second layer and decrease in the adhesive property of the coated film can be prevented even when the coated film is irradiated with ultraviolet light under high humidity environment and when the coated film is in wet state while maintaining the antifog property expressed by the first layer.

While whitening of the coated film and decrease in the coated film adhesive property can be suppressed if a benzophenone-based ultraviolet light absorber were to be added to the coated film of the second layer instead of a benzotriazole-based ultraviolet light absorber, this would inhibit the antifog property. This is presumably due to the fact that, because the second layer is a coated film having a high cross-linking density, if the benzophenone-based ultraviolet light absorber is added to such an extent that whitening of the coated film and decrease in the coated film adhesive property can be suppressed, poor compatibility results between the benzophenone-based ultraviolet light absorber and the coated film of the second layer, inhibiting the antifog property expressed by the first layer. Also, if the benzotriazole-based ultraviolet light absorber were to be added only to the coated film of the first layer, whitening of the coated film of the second layer and decrease in the coated film adhesive property cannot be prevented since the second layer would be irradiated with ultraviolet light under high humidity environment and when the coated film is in wet state.

On the other hand, when a specific amount of the benzotriazole-based ultraviolet light absorber is added to the coated film of the second layer to which ultraviolet light is directly irradiated, because the benzotriazole-based ultraviolet light absorber has good compatibility with the coated film of the second layer, whitening of the coated film of the first layer and the second layer and decrease in the coated film adhesive property can be prevented while maintaining the antifog property expressed by the first layer even when the coated film is irradiated with ultraviolet light under high humidity environment and when the coated film is in wet state.

### EXAMPLES

In the following, the present invention will be described based on examples. The “parts” and “%” are with respect to weight unless otherwise specifically noted.

### 1. Manufacture of Antifog Sheet

### Example 1

First, the first coating composition and the second coating composition were prepared according to the following formula.

### <First Coating Composition of Example 1>

| | |
|---|---|
| Methyl silicate (MS-56: Mitsubishi Chemical Corporation) | 5.0 parts |
| Silane coupling agent (SH 6040: Dow Corning Toray | 0.3 parts |
| Co., Ltd.) | |
| Partial saponified PVA (Kishida Chemical Co., Ltd.) | 5.0 parts |
| (solid content 100%, saponification degree 87 to 89 | |
| mol %, average polymerization degree 3500) | |
| Polyacrylic acid (AC-10H: Nihon Pure Chemical Co. Ltd.) | 5.0 parts |
| (solid content 100%) | |
| Methanol | 40.0 parts |
| Water | 44.5 parts |

### <Second Coating Composition of Example 1>

| | | |
|---|---|---|
| Benzotriazole-based ultraviolet light absorber | 1.1 | parts |
| (Adeka Stab LA-32: Adeka Corporation, chemical | | |
| name: 2-(2-hydroxy-5-methylphenyl) benzotriazole, | | |
| molecular weight 225) | | |
| Methyl silicate (MS- 56: Mitsubishi Chemical | 5.0 | parts |
| Corporation) | | |
| Silane coupling agent | 0.3 | part |
| (SH6040: Dow Corning Toray Co., Ltd.) | | |
| Polyethylene glycol (Kishida Chemical Co., Ltd.) | 30.0 | parts |
| Isocyanate-based curing agent | 20.0 | parts |
| (MF-K60X: Asahi Kasei Chemicals Corporation) | | |
| diacetone alcohol | 30.0 | parts |
| t-butanol | 14.7 | parts |

The amount of 1.1 part of the benzotriazole-based ultraviolet light absorber “Adeka Stab LA-32” in Example 1 is 1.95 wt % in solid content equivalent in the second coating composition.

The prepared first coating composition was applied to a plastic film (Lumirror T60: Toray Industries, Inc.) as the base member with a thickness of 100 μm at a pulling rate of 50 mm/min using a dip coating device. Thereafter, heating and drying (heating process) was performed at 150° C. for 10 minutes. As a result, a colorless and transparent first layer was uniformly formed to a thickness of 3 μm on the base member.

Then, onto the first layer, the second coating composition of the above-described composition was applied at a pulling rate of 30 mm/min using the dip coating device. Thereafter, drying (heating process) was performed at 100 to 120° C. in a drying furnace for 15 minutes. As a result, a transparent second layer was formed on the first layer to a thickness of approximately 5 μm, obtaining the antifog sheet according to the present example.

### Example 2

The antifog sheet of the present example was obtained in the same conditions as in Example 1 with the exception that the amount of the benzotriazole-based ultraviolet light absorber “Adeka Stab LA-32” in the second coating composition of Example 1 was 2.77 parts. The amount used in the second coating composition was 4.8 wt %, in solid content equivalent.

### Example 3

The antifog sheet of the present example was obtained in the same conditions as in Example 1 with the exception that the amount of the benzotriazole-based ultraviolet light absorber “Adeka Stab LA-32” in the second coating composition of Example 1 was 3.87 parts. The amount used in the second coating composition was 6.5 wt % in solid content equivalent.

### Example 4

The antifog sheet of the present example was obtained in the same conditions as in Example 1 with the exception that the amount of the benzotriazole-based ultraviolet light absorber “Adeka Stab LA-32” in the second coating composition of Example 1 was 4.42 parts. The amount used in the second coating composition was 7.4 wt % in solid content equivalent.

### Example 5

The antifog sheet of the present example was obtained in the same conditions as in Example 1 with the exception that the benzotriazole-based ultraviolet light absorber “Adeka Stab LA-32” in the second coating composition of Example 1 was changed to 1.1 parts of a benzotriazole-based ultraviolet light absorber (Sumisorb 300: Sumika Chemtex Co., Ltd., chemical name: 2-(5-chloro-2-benzotriazolyl)-6-tertiary-butyl-p-cresol, molecular weight 315). The amount used in the second coating composition was 1.95 wt % in solid content equivalent.

### Example 6

The antifog sheet of the present example was obtained in the same conditions as in Example 5 with the exception that the amount of the benzotriazole-based ultraviolet light absorber “Sumisorb 300” in the second coating composition of Example 5 was 2.77 parts. The amount used in the second coating composition was 4.8 wt % in solid content equivalent.

### Example 7

The antifog sheet of the present example was obtained in the same conditions as in Example 5 with the exception that the amount of the benzotriazole-based ultraviolet light absorber “Sumisorb 300” in the second coating composition of Example 5 was 3.87 parts. The amount used in the second coating composition was 6.5 wt % in solid content equivalent.

### Example 8

The antifog sheet of the present example was obtained in the same conditions as in Example 5 with the exception that the amount of the benzotriazole-based ultraviolet light absorber “Sumisorb 300” in the second coating composition of Example 5 was 4.42 parts. The amount used in the second coating composition was 7.4 wt % in solid content equivalent.

### Example 9

The antifog sheet of the present example was obtained in the same conditions as in Example 1 with the exception that the benzotriazole-based ultraviolet light absorber “Adeka Stab LA-32” used in the second coating composition of Example 1 was changed to 1.1 parts of a benzotriazole-based ultraviolet light absorber (Sumisorb 250: Sumika Chemtex Co., Ltd., chemical name: N-[3-(2H-benzotriazole-2-yl)-2-hydroxy-5-methylbenzyl]-3,4,5,6-tetra hydrophthalimide, molecular weight 388). The amount used in the second coating composition was 1.95 wt % in solid content equivalent.

### Example 10

The antifog sheet of the present example was obtained in the same conditions as in Example 9 with the exception that the amount of the benzotriazole-based ultraviolet light absorber “Sumisorb 250” in the second coating composition of Example 9 was 2.77 parts. The amount used in the second coating composition was 4.8 wt % in solid content equivalent.

### Example 11

The antifog sheet of the present example was obtained in the same conditions as in Example 9 with the exception that the amount of the benzotriazole-based ultraviolet light absorber “Sumisorb 250” in the second coating composition of Example 9 was 3.87 parts. The amount used in the second coating composition was 6.5 wt % in solid content equivalent.

### Example 12

The antifog sheet of the present example was obtained in the same conditions as in Example 9 with the exception that the amount of the benzotriazole-based ultraviolet light absorber “Sumisorb 250” in the second coating composition of Example 9 was 4.42 parts. The amount used in the second coating composition was 7.4 wt % in solid content equivalent.

### Comparative Example 1

The antifog sheet of the present comparative example was obtained in the same conditions as in Example 1 with the exception that the benzotriazole-based ultraviolet light absorber “Adeka Stab LA-32” was not added in the second coating composition of Example 1. The amount in the second coating composition was 0 wt % in solid content equivalent.

### Comparative Example 2

The antifog sheet of the present comparative example was obtained in the same conditions as in Example 1 with the exception that the amount of the benzotriazole-based ultraviolet light absorber “Adeka Stab LA-32” in the second coating composition of Example 1 was 5.53 parts. The amount used in the second coating composition was 9.1 wt % in solid content equivalent.

### Comparative Example 3

The antifog sheet of the present comparative example was obtained in the same conditions as in Example 1 with the exception that the benzotriazole-based ultraviolet light absorber “Adeka Stab LA-32” in the second coating composition of Example 1 was changed to 1.1 parts of benzophenone-based ultraviolet light absorber (Kemisorb 11: Chemipro Kasei, chemical name: 2-hydroxy-4-methoxybenzophenone, molecular weight 228). The amount of in the second coating composition was 1.95 wt % in solid content equivalent.

### Comparative Example 4

The antifog sheet of the present comparative example was obtained in the same conditions as in Comparative Example 3 with the exception that the amount of the benzophenone-based ultraviolet light absorber “Kemisorb 11” in the second coating composition of Example 3 was 2.77 parts. The amount used in the second coating composition was 4.8 wt % in solid content equivalent.

### Comparative Example 5

The antifog sheet of the present comparative example was obtained in the same conditions as in Comparative Example 3 with the exception that the amount of the benzophenone-based ultraviolet light absorber “Kemisorb 11” in the second coating composition of Example 3 was 3.87 parts. The amount used in the second coating composition was 6.5 wt % in solid content equivalent.

### Comparative Example 6

The antifog sheet of the present comparative example was obtained in the same conditions as in Example 1 with the exception that the benzotriazole-based ultraviolet light absorber “Adeka Stab LA-32” in the second coating composition of Example 1 was changed to 1.1 parts of benzotriazole-based ultraviolet light absorber (Eversorb 78: Everlight Chemical Industrial Corp., chemical name: 2,2′methylenebis[6-(benzotriazole-2-yl)-4-tert-octyl phenol], molecular weight: 658). The amount used in the second coating composition was 1.95 wt % in solid content equivalent.

### Comparative Example 7

The antifog sheet of the present comparative example was obtained in the same conditions as in Comparative Example 6 with the exception that the amount of the benzotriazole-based ultraviolet light absorber “Eversorb 78” in the second coating composition was 2.77 parts. The amount used in the second coating composition of Example 6 was 4.8 wt % in solid content equivalent.

### 2. Evaluation

The antifog sheets according to Examples 1 to 12 and Comparative Examples 1 to 7 were subjected to an accelerated weather resistance test for 250 hours according to JIS-A5759-2008, using a sunshine carbon arc lamp type weather resistance testing machine (Suga Test Instruments Co., Ltd.) involving ultraviolet irradiation and water spraying on the antifog layer side. The antifog sheets subjected to the accelerated weather resistance test were evaluated in the following items. The results are shown in Table 1.

### (1) Evaluation of Antifog Property

The antifog sheets subjected to the accelerated weather resistance test were housed in a refrigerator (approximately 0° C.) for 5 minutes, and then let stand in an atmosphere of 23° C. and 55% RH. The antifog sheets that did not have any fogging on the coated film surface of the antifog sheet were evaluated to be “Good”; those with slight fogging were evaluated to be “Poor”; and those with fogging were evaluated to be “Bad”.

### (2) Evaluation of Whitening of the Coated Film.

The antifog sheets that had been subjected to the accelerated weather resistance test were subjected to an appearance evaluation. Those in which no whitening was observed in the coated film of the first layer and the second layer of the antifog sheet were evaluated to be “Good”; those with slight whitening were evaluated to be “Poor”; and those with whitening were evaluated to be “Bad”.

### (3) Evaluation of Adhesive Property of the Coated Film

The antifog sheet that had been subjected to the accelerated weather resistance test were dried and then measured by the cross-cut tape method according to JIS-K5400: 1990, to evaluate the adhesive property between the base material and the first layer. Those in which the area of the cross-cut portion was peeled by 10% or more were evaluated to be “Bad”; those with peeling of not less than 5% and less than 10% were evaluated to be “Poor”; and those with peeling of less than 5% were evaluated to be “Good”.

TABLE 1

| | Ultraviolet light | Molecular | Amount used | | Whitening of coated | Adhesive property of |
|---|---|---|---|---|---|---|
| | absorber | weight | (wt %) | Antifog property | film | coated film |
| Example 1 | Benzo triazole-based | 225 | 1.95 | Good | Good | Good |
| Example 2 | Benzo triazole-based | 225 | 4.8 | Good | Good | Good |
| Example 3 | Benzo triazole-based | 225 | 6.5 | Poor | Good | Good |
| Example 4 | Benzo triazole-based | 225 | 7.4 | Poor | Good | Good |
| Example 5 | Benzo triazole-based | 315 | 1.95 | Good | Good | Good |
| Example 6 | Benzo triazole-based | 315 | 4.8 | Good | Good | Good |
| Example 7 | Benzo triazole-based | 315 | 6.5 | Poor | Good | Good |
| Example 8 | Benzo triazole-based | 315 | 7.4 | Poor | Good | Good |
| Example 9 | Benzo triazole-based | 388 | 1.95 | Good | Good | Good |
| Example 10 | Benzo triazole-based | 388 | 4.8 | Poor | Good | Good |
| Example 11 | Benzo triazole-based | 388 | 6.5 | Poor | Good | Good |
| Example 12 | Benzo triazole-based | 388 | 7.4 | Poor | Good | Poor |
| Comparative | None | — | — | Good | Bad | Bad |
| Example 1 | | | | | | |
| Comparative | Benzotriazole-based | 225 | 9.1 | Bad | Good | Good |
| Example 2 | | | | | | |
| Comparative | Benzophenone-based | 228 | 1.95 | Poor | Bad | Bad |
| Example 3 | | | | | | |
| Comparative | Benzophenone-based | 228 | 4.8 | Bad | Good | Good |
| Example 4 | | | | | | |
| Comparative | Benzophenone-based | 228 | 6.5 | Bad | Good | Good |
| Example 5 | | | | | | |
| Comparative | Benzotriazole-based | 658 | 1.95 | Bad | Good | Good |
| Example 6 | | | | | | |
| Comparative | Benzotriazole-based | 658 | 4.8 | Bad | Good | Good |
| Example 7 | | | | | | |

### 3. Analysis

The results of Table 1 are summarized as follows.

In the antifog sheets according to Examples 1 to 12, the first layer and the second layer are successively layered on the base member, the first layer including a water absorbing resin and the second layer including polyol and benzotriazole-based ultraviolet light absorber by 1.5 to 8 wt % in solid content equivalent. Thus, these examples had good evaluation of antifog property, and also had good evaluation in terms of whitening of the coated film and adhesive property of the coated film.

Particularly, they antifog sheets according to Examples 1, 2, 5, and 6, in which the amount of the benzotriazole-based ultraviolet light absorber in the second layer was 1.9 to 5 wt % in solid content equivalent, had no fogging and therefore evaluated to be good, and were also evaluated to be good in terms of whitening of the coated film and the adhesive property of the coated film. As the amount of the benzotriazole-based ultraviolet light absorber used increased, the evaluation of antifog property tended to be lowered. In Examples 9 to 12 in which the benzotriazole-based ultraviolet light absorber had a molecular weight of 350 or more, the antifog property was maintained up to the amount used of 2 wt % but slightly decreased above 4 wt %.

The antifog sheet according to Comparative Example 1, which had no benzotriazole-based ultraviolet light absorber in the second layer, had no fogging and had good evaluation of antifog property. However, the coated film of the antifog sheet became whitened and had bad evaluation in terms of coated film adhesive property. The antifog sheet according to Comparative Example 2, which had more than 8 wt % of the benzotriazole-based ultraviolet light absorber included in the second layer, had good evaluation of whitening of the coated film and the coated film adhesive property. However, Comparative Example 2 had fogging and therefore bad antifog property evaluation.

The antifog sheets according to Comparative Examples 3 to 5 included the benzophenone-based ultraviolet light absorber instead of the benzotriazole-based ultraviolet light absorber in the second layer. Decrease in antifog property was small when the amount of the light absorber was 1.95 wt % in solid content equivalent (Comparative Example 3): however, the evaluation in terms of whitening of the coated film and the coated film adhesive property was bad. When the amount in solid content equivalent was 4.8 wt % or 6.5 wt % (Comparative Example 4 or 5), the evaluation of whitening of the coated film and coated film adhesive property was good; however, fogging developed and the antifog evaluation was bad.

Comparative Examples 6 and 7, in which the second layer included the benzotriazole-based ultraviolet light absorber with the molecular weight of 500 or more, had good evaluation of whitening of the coated film and coated film adhesive property. However, even when the amount of the light absorber used was decreased, fogging developed and the antifog evaluation was bad.

Thus, it was confirmed that in all of the antifog sheets according to the Examples, whitening of the coated film of the first layer or the second layer and decrease in the coated film adhesive property can be prevented while maintaining antifog property even when the coated film is irradiated with ultraviolet light under high humidity environment and when the coated film is in wet state.

1-11. (canceled)

12. An antifog sheet comprising a first layer and a second layer successively layered on a base material, wherein:
the first layer includes a water absorbing resin and the second layer includes a polyol and a benzotriazole-based ultraviolet light absorber with a molecular weight of not more than 500; and
the second layer has a benzotriazole-based ultraviolet light absorber content of 1.5 to 8 wt %.

13. The antifog sheet according to claim 12, wherein the molecular weight of the benzotriazole-based ultraviolet light absorber is not more than 350.

14. The antifog sheet according to claim 12, wherein the benzotriazole-based ultraviolet light absorber content is not more than 4 wt %.

15. The antifog sheet according to claim 12, wherein the benzotriazole-based ultraviolet light absorber content is not more than 5 wt %.

16. The antifog sheet according to claim 12, wherein the water absorbing resin includes at least one of a polyvinyl alcohol and a polyacrylic acid.

17. The antifog sheet according to claim 12, wherein the second layer includes a heat treated product of a coating composition including polyol and benzotriazole-based ultraviolet light absorber.

18. The antifog sheet according to claim 17, wherein the coating composition includes at least one compound selected from a metal alkoxide, a hydrolysate of a metal alkoxide, and a hydrolyzed polycondensate of a metal alkoxide.

19. The antifog sheet according to claim 17, wherein the coating composition includes a curing agent.

20. The antifog sheet according to claim 12, wherein:
the first layer includes a heat treated product of a first coating composition including a water absorbing resin; and
the second layer includes a heat treated product of a second coating composition including polyol and benzotriazole-based ultraviolet light absorber.

21. The antifog sheet according to claim 20, wherein at least one of the first coating composition and the second coating composition includes at least one compound selected from a metal alkoxide, a hydrolysate of a metal alkoxide, and a hydrolyzed polycondensate of a metal alkoxide.

22. The antifog sheet according to claim 20, wherein at least one of the first coating composition and the second coating composition includes a curing agent.

23. The antifog sheet according to claim 13, wherein the benzotriazole-based ultraviolet light absorber content is not more than 4 wt %.

24. The antifog sheet according to claim 13, wherein the benzotriazole-based ultraviolet light absorber content is not more than 5 wt %.

25. The antifog sheet according to claim 13, wherein the water absorbing resin includes at least one of a polyvinyl alcohol and a polyacrylic acid

26. The antifog sheet according to claim 14, wherein the water absorbing resin includes at least one of a polyvinyl alcohol and a polyacrylic acid.

27. The antifog sheet according to claim 15, wherein the water absorbing resin includes at least one of a polyvinyl alcohol and a polyacrylic acid.

28. The antifog sheet according to claim 18, wherein the coating composition includes a curing agent.

29. The antifog sheet according to claim 21, wherein at least one of the first coating composition and the second coating composition includes a curing agent.
